(19) United States
(12) Patent Application Publication
(10) Pub. No.: US 2025/0002336 A1
(43) Pub. Date: Jan. 2, 2025

(54) SYSTEMS AND METHODS FOR REDOX ENERGY RECOVERY

(71) Applicant: OHIO STATE INNOVATION FOUNDATION, Columbus, OH (US)

(72) Inventors: Liang-Shih Fan, Columbus, OH (US); Andrew Tong, Columbus, OH (US); Rushikesh Joshi, Columbus, OH (US); Dawei Wang, Columbus, OH (US); Vedant Shah, Columbus, OH (US); Dikai Xu, Columbus, OH (US)

(21) Appl. No.: 18/705,738

(22) PCT Filed: Nov. 24, 2021
(86) PCT No.: PCT/US2021/060744

§ 371 Date: Apr. 29, 2024

(51) Int. Cl. C01B 3/06; B01J 8/18; B01J 8/26

(52) U.S. Cl. CPC C01B 3/063; B01J 8/1827; B01J 8/26; B01J 2208/00548; B01J 2208/00769

(57) ABSTRACT

An example method for operating an energy recovery system may comprise providing a reducing gas stream to an inlet of the energy recovery system, contacting redox particles with the reducing gas stream, whereupon the at least one reducing gas species undergoes a chemical reaction with the redox particles to generate carbon dioxide (CO₂) and/or steam (H₂O) obtaining a first product stream from the energy recovery system, providing an oxidizing gas stream comprising steam (H₂O) to the energy recovery system such that hydrogen gas (H₂) is generated, and obtaining a second product stream from the energy recovery system, the second product stream comprising hydrogen gas (H₂). The reducing gas stream may comprise at least one reducing gas species comprising at least one of carbon monoxide (CO), methane (CH₄), hydrocarbons (C₂₊), hydrogen gas (H₂), and carbon dioxide (CO₂). The first product stream may comprise carbon dioxide (CO₂) and steam (H₂O).

### FIELD

The present disclosure relates to systems and methods for recovering and storing energy using redox processes. In some instances, exemplary redox processes may utilize fixed beds. In some instances, redox particles may utilize moving beds and may convey redox particles between exemplary system components.

### INTRODUCTION

There is a continuing need for systems that generate clean and efficient energy. Currently, many commercial processes generate energy carriers such as steam, hydrogen, synthesis gas (syngas), liquid fuels and/or electricity mainly from fossil fuels. It is expected that in the foreseeable future, the energy resources will still rely on fossil fuels due to their much lower costs compared to renewable sources. However, combustion of carbonaceous fuels is a carbon intensive process that emits large quantities of carbon dioxide into the environment. Other harmful gases, such as sulfur and nitrogen compounds, are also generated in this process due to the complex content in fossil fuels. Chemical reactions between metal oxides and carbonaceous fuels, on the other hand, may provide a better way to recover the energy stored in the fuels. As demands increase for cleaner and more efficient systems of converting fuel, the need arises for improved systems that will convert fuel effectively.

Even though renewable sources are being used to meet the energy requirements, fossil fuels remain the major source for energy generation. It is projected that the total fossil fuel-derived energy will account for ˜77% of the total energy production by 2050. The bulk chemicals industry is projected to consume ˜35% of the total industrial energy consumption in the U.S. by 2050 as the demand for chemicals like hydrogen, syngas, methanol, ammonia, etc. is forecasted to increase because they serve as building blocks of the chemical industry and are widely used for manufacturing petrochemicals, fertilizers, and oxo chemicals among others. However, the utilization of fossil fuels as feedstocks coupled with the conventional product syntheses routes renders these processes both economically and environmentally unwanted due to high capital and operating costs. Apart from the rampant use of natural gas/shale gas for chemical production, solid fuels such as coal and petroleum coke are also utilized for both power generation and syngas production through partial oxidation.

### SUMMARY

In one aspect, a method for operating an energy recovery system is disclosed. The exemplary method may comprise providing a reducing gas stream to an inlet of the energy recovery system, where the reducing gas stream comprises at least one reducing gas species comprising at least one of carbon monoxide (CO), methane (CH₄), hydrocarbons (C₂₊), hydrogen gas (H₂), and carbon dioxide (CO₂). The exemplary method may also comprise contacting redox particles with the reducing gas stream, whereupon the at least one reducing gas species undergoes a chemical reaction with the redox particles to generate carbon dioxide (CO₂) and/or steam (H₂O). The exemplary method may additionally comprise obtaining a first product stream from the energy recovery system, the first product stream comprising carbon dioxide (CO₂) and steam (H₂O). The exemplary method may additionally comprise providing an oxidizing gas stream comprising steam (H₂O) to the energy recovery system such that hydrogen gas (H₂) is generated. The exemplary method may additionally comprise obtaining a second product stream from the energy recovery system, the second product stream comprising hydrogen gas (H₂).

In another aspect, a reactor system is disclosed. The exemplary reactor system may comprise a first reactor comprising redox particles; a second reactor in fluid communication with the reducer reactor and configured to receive the redox particles from the reducer reactor; a combustor reactor in fluid communication with the oxidizer reactor and configured to receive the redox particles from the oxidizer reactor, where the combustor reactor comprises a particle flow control module; and a conveying system in communication with the particle flow control module and the reducer reactor, the conveying system configured to mechanically convey the redox particles from the particle flow control module to the reducer reactor.

There is no specific requirement that a material, technique or method relating to energy recovery include all of the details characterized herein, in order to obtain some benefit according to the present disclosure. Thus, the specific examples characterized herein are meant to be exemplary applications of the techniques described, and alternatives are possible.

### BRIEF DESCRIPTION OF THE DRAWINGS

FIG. 1 schematically illustrates an example system comprising a recovery system in communication with a process.

FIG. 2A and FIG. 2B show schematic depictions of co-current fixed bed and countercurrent fixed bed configurations, respectively. FIG. 2C and FIG. 2D show schematic depictions of crosscurrent modes of operation.

FIG. 3A and FIG. 3B show schematic depictions of co-current fixed bed and countercurrent fixed bed configurations, respectively, for syngas generation.

FIG. 4 shows a schematic depiction of hydrogen generation wherein multiple fixed bed reactors comprising metal oxide-based redox particles are in fluid communication with at least one vapor-liquid separation unit.

FIG. 5 shows a schematic depiction of a system configured for heat recovery.

FIG. 6 shows a schematic depiction of a system configured for air separation.

FIG. 7A shows a schematic depiction of a system configured to generate pure streams of CO₂ and hydrogen by utilizing another reactor(s) comprising materials capable or selectively removing CO₂. FIG. 7B shows a schematic depiction of a system wherein a CO₂ removal sorbent is fed into the fixed bed reactors along with the metal oxide-based redox particles for selective CO₂ capture.

FIG. 8 is a computationally generated plot showing enhancement in hydrogen (H₂) yield upon in-situ removal of CO₂.

FIG. 9 shows a schematic configuration of a fixed bed reactor that utilizes a CO₂-selective membrane placed inside the reactor surrounding the metal oxide-based redox capable particles.

FIG. 10A shows a schematic depiction of two sets of reactors, where each set of reactors includes more than one reactor operating in parallel. FIG. 10B shows a theoretical hydrogen yield for the system shown in FIG. 10A.

FIG. 11 shows the representation of a system with pneumatic conveying device

FIG. 12 shows the representation of overall system with mechanical conveying device

FIG. 13 illustrates a configuration of combustor with solids discharge

FIG. 14 illustrates a configuration of combustor with solids discharge

FIG. 15 illustrates a configuration of combustor with solids discharge

FIG. 16 illustrates a configuration of carrying bucket inlet

FIG. 17 illustrates a configuration of carrying bucket outlet

FIG. 18 shows a layout of system with fixed bed configuration

FIG. 19 shows an application of the system

FIG. 20 shows process diagram of energy storage systems

FIG. 21 shows experimental results for a fixed bed receiving dilute methane gas in an exemplary system at 1000° C., 1 atm.

FIG. 22A shows experimental results for a fixed bed sample steam oxidation and hydrogen generation, after bed reduction, where oxidizing gas is provided in co-current fashion.

FIG. 22B shows experimental results for a fixed bed sample steam oxidation and hydrogen generation, after bed reduction, where oxidizing gas is provided in counter-current fashion.

FIG. 23 shows experimental results for fixed bed sample CO₂ oxidation, after bed reduction, where oxidizing gas CO₂ is provided in counter-current fashion for CO generation reaction.

### DETAILED DESCRIPTION

Systems, methods and techniques disclosed herein relate to redox energy recovery utilizing reducing gas streams originating from various sources. Exemplary sources may include chemical, petrochemical, refining, mining, metallurgical, ceramic, mineral, energy, bio-allied, agricultural or related environments which may generate carbonaceous streams, including carbonaceous waste gas streams. Exemplary implementations use metal oxide-based redox particles, where reducing gas streams are used to abstract oxygen from the metal oxide lattice and thereby reduce the material, which then acts as an energy reservoir. This reservoir may be further used for product generation through regeneration/oxidation of the reduced material using suitable oxidizing agents. Exemplary systems, methods and techniques may result in the utilization and subsequent conversion of reducing gas streams into value-added products in an energy and cost-efficient manner, which are otherwise rendered waste streams.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, the term “ambient pressure” refers to the pressure of the external environment at the location at which the system and/or the process of the present disclosure is operated. The ambient pressure is typically atmospheric pressure

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated. For example, when a pressure range is described as being between ambient pressure and another pressure, a pressure that is ambient pressure is expressly contemplated.

### II. Exemplary Chemical Constituents

Exemplary systems and methods may utilize various chemical constituents in fluid and solid forms. Various aspects of exemplary chemical constituents are described below.

Exemplary systems and methods may use redox particles. Generally, redox particles are redox capable material, also known as oxygen carriers, whose reduced state can act as an energy reservoir. Exemplary redox particles may comprise metal oxides and/or their derivatives that can undergo cyclic reduction and oxidation, which is accompanied by a change in the oxidation state of one or more chemical species present in the material. Exemplary systems disclosed herein may comprise one or more of these types of metal oxide-based materials, whose selection may be subjected to performance parameters such as reactivity, recyclability, particle size, mechanical strength, and the oxygen carrying capacity. Exemplary redox particles may include one or more than one type of metal oxides where at least one of the constituents undergoes lowering of oxidation state in the presence of reducing gases and show an increment in the oxidation state during regeneration using suitable oxidizing agents.

Exemplary redox particles may comprise metal oxides or their derivatives such as the oxides of iron, copper, nickel, manganese, cobalt, zinc, chromium, cerium, titanium, calcium, potassium, sodium, lithium, lanthanum, magnesium, or combinations thereof. In some instances, exemplary redox particles may be an Fe-based redox pair (FeOₓ—FeO_{y}, 0≤y<x≤1.33) or Ni-based redox pair (NiOₓ—NiO_{y}, 0≤y≤x≤1) or Mn-based redox pair (MnOₓ—MnO_{y} 0≤y≤x≤4) or Cu-based redox pair (CuOₓ—CuO_{y}, 0≤y≤x≤1) or Co-based redox pair (CoOₓ—CoO_{y} 0≤y≤x≤1.33).

Recyclability and strength of exemplary redox particles may be enhanced by adding support metal oxides, wherein the support material added to the redox particles may include SiO₂, SiC, Al₂O₃, MgO, CaO, TiO₂, MgAl₂O₄, ZrO₂, Y stabilized ZrO₂, alumina-silicates, clay supports like kaolin and bentonite, alumina-zirconia-silica, etc. or any combinations comprising two or more support materials. Other support materials known in the art may also be used.

Active metal oxides (materials that lose and gain lattice oxygen) can constitute 10-90 wt % of the total loading present in the redox particles, with the difference comprising support materials, promoters, and dopants. In some instances, exemplary redox particles may comprise at least 10 wt %; at least 20 wt %; at least 30 wt %; at least 40 wt %; at least 50 wt %; at least 60 wt %; at least 70 wt %; at least 80 wt % or at least 90 wt % metal oxides. In some instances, exemplary redox particles may comprise no more than 90 wt %; no more than 80 wt %; no more than 70 wt %; no more than 60 wt %; no more than 50 wt %; no more than 40 wt %; no more than 30 wt %; no more than 20 wt %; or no more than 10 wt % metal oxides.

Oxide, metallic, and other derivatives of elements including but not limited to Na, Li, K, Mg, Ca, Sr, Ba, Ce, La, Be, Ni, Co, Cu, Sc, Ti, V, Cr, Mn, Zn, Y, Zr, Nb, Mo, Tc, Ru, Rh, Pd, Ag, Cd, Lu, Hf, Ta, W, Re, Os, Ir, Pt, and Au may be added as dopants and promoters. These materials may provide active sites for the adsorption of reactant gas molecules and also creation of oxygen vacancies in the lattice, thereby enhancing the rates of ionic diffusion and lowering the activation energy barrier for product formation. Exemplary compositions of redox particles may relate to reactivity, strength, and/or product selectivity.

Exemplary redox particles may have various sizes, which can be measured in terms of diameter, average diameter, and/or d90 diameter. Size (diameter) of exemplary redox particles may affect the reaction rate and/or system hydrodynamics, because a change in the particle size can propel a change in the reactor vessel sizing. Additionally, a change in the particle size may affect surface-to-volume ratios, in turn affecting the reaction kinetics. Size of exemplary redox particles may relate to process parameters of exemplary systems, such as the minimum fluidization velocity and pressure drop across the reactor. As an example, exemplary redox particles may have an average diameter between about 0.01 mm and about 5 mm. In some instances, exemplary redox particles may have an average diameter between 0.01 mm and 5.0 mm; between 0.01 mm and 2.5 mm; between 2.5 mm and 5.0 mm; between 0.1 mm and 5.0 mm; between 0.01 mm and 1.0 mm; between 1.0 mm and 3.0 mm; or between 3.0 mm and 5.0 mm. In various instances, exemplary redox particles may have an average diameter of no less than 0.01 mm; no less than 0.05 mm; no less than 0.1 mm; no less than 0.5 mm; no less than 1.0 mm; no less than 2.0 mm; no less than 3.0 mm; or no less than 4.0 mm. In various instances, exemplary redox particles may have an average diameter of no greater than 5.0 mm; no greater than 4.0 mm; no greater than 3.0 mm; no greater than 2.0 mm; no greater than 1.0 mm; no greater than 0.5 mm; no greater than 0.1 mm; or no greater than 0.05 mm.

Similar to the particle size, particle density may affect system hydrodynamics. For the particles constituting redox material in exemplary systems, redox particle density can vary from 500-9000 kg/m³.

Exemplary redox particles can also enable efficient heat transfer across the reduction and oxidation operations of a redox cycle. Consequently, exemplary redox particles may comprise one or more active component(s) capable of undergoing redox (e.g., Fe₂O₃) and an inert material, such as an inert metal oxide (e.g., MgO, Al₂O₃, etc.). Typically, inert material used in exemplary redox particles have high heat carrying capacity which may ensure heat balance across the redox operations. The presence of an inert metal oxide or a combination of inert metal oxides along with the active component(s) may provide both physical strength as well as heat bearing capacity.

Certain exemplary systems and methods may involve two or more types of particles. For example, redox particles may be used in addition to inert material particles. In some instances, more than one type of redox particle may be used. In some instances, more than one type of inert material particle may be used. Exemplary inert materials may help maintain desired operating temperatures and may increase energy efficiency by lowering the temperature drop during reduction operations, which may be attributable to endothermic nature of the metal oxide (redox particles) reduction reactions.

Inert material particles may have various sizes. For instance, inert materials may be the same size, or different size than redox particles. The size of inert material can be between 1% to 100 times of the size of redox particles. Multiple types of inert materials with different sizes, densities and other physical and chemical properties can be used at the same time.

Various reducing gases may be provided to exemplary systems. In some instances, reducing gases may comprise waste gas streams exiting high-temperature furnaces, tail gases, natural gas/shale gas/methane (as makeup), biogas, and reducing gases from any chemical, petrochemical, mining, metallurgical, ceramic, energy processes. In some instances, reducing gases may comprise methane (CH₄), ethane (C₂H₆), hydrogen (H₂), carbon monoxide (CO), ethylene(C₂H₄), propane (C₃H₈), propylene (C₃H₆) and other C₂₊ hydrocarbons and combinations thereof.

Various oxidizing gases may be provided to exemplary systems. In some instances, exemplary oxidizing gas streams may comprise steam (H₂O). In some instances, exemplary oxidizing gas streams may comprise steam (H₂O) and carbon dioxide (CO₂). In some instances, exemplary oxidizing gas streams may comprise steam (H₂O), carbon dioxide (CO₂), and one or more NOx gases, such as nitric oxide (NO) and nitrogen dioxide (NO₂).

### III. Exemplary Systems

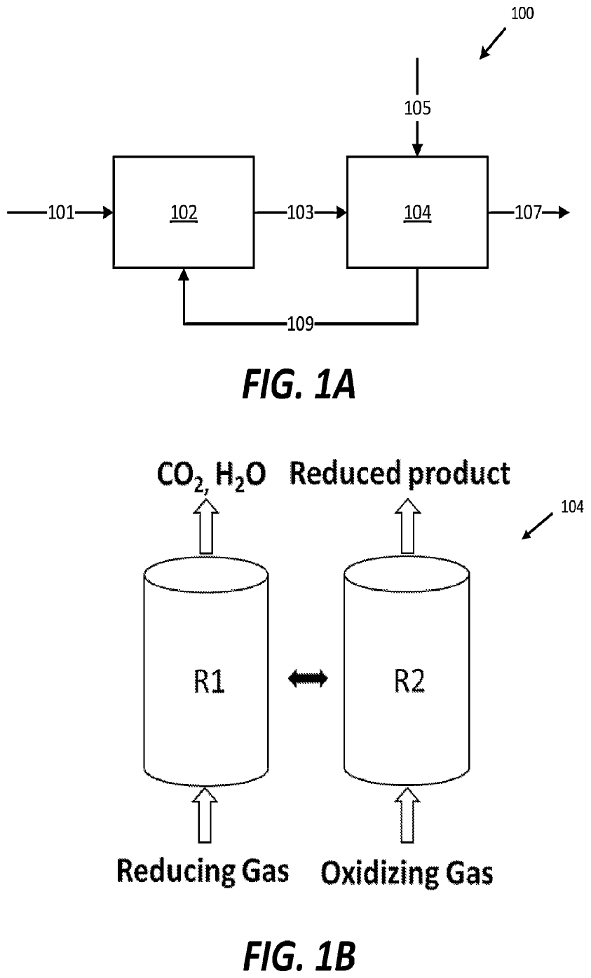

FIG. 1A schematically illustrates an example system 100 comprising recovery system 104 in communication with process 102. Other embodiments may comprise more or fewer components.

Process 102 may be various processes that receive fuel and provide an output. In some instances, process 102 receives carbonaceous fuel in input 101. In some instances, input 101 may additionally comprise one or more inert components.

Process 102 generates output 103 that is provided to recovery system 104. In some instances, output 103 may comprise a dilute stream comprising low concentrations of reducing carbon-based fuels. In some instances, output 103 may comprise unconverted reducing fuels such as CO and H₂ mixed with inert species such as N₂ and combustion products such as CO₂ and H₂O. In some instances, output 103 may comprise waste gas streams exiting high-temperature furnaces, tail gases, natural gas/shale gas/methane (as makeup), biogas, and reducing gases from any chemical, petrochemical, refining, mining, metallurgical, ceramic, mineral, energy, bio-allied, agricultural or related environments.

Recovery system 104 receives output 103 from process 102 and input stream 105. Generally, recovery system 104 comprises one or more reactors configured to perform reduction and oxidation operations. Recovery system 104 comprises various particles, such as redox particles and inert material particles as described above. During typical operation, redox particles may be reduced to a lower oxidation state, oxidizing the reducing fuels, and the energy recovery from the reduced metal oxides may be carried out using their oxidation. Reduced metal oxides may be subjected to one or more oxidation operations with CO₂ and H₂O to produce concentrated H₂ and CO. Various configurations of recovery system 104 are described in greater detail below.

In some instances, input stream 105 may comprise steam (H₂O). In some instances, input stream 105 may comprise steam (H₂O) and carbon dioxide (CO₂). Broadly, recovery system 104 generates an output 109 comprising carbon monoxide (CO) and/or hydrogen gas (H₂), which may be recycled back to process 102. Recovery system 104 may also generate output 107 that may comprise steam (H₂O) and carbon dioxide (CO₂), and potentially one or more inert components, along with some unconverted input gases.

FIG. 1B shows an exemplary two reactor recovery system 104. As shown, a first reactor R1 receives reducing gas and, simultaneously, a second reactor receives oxidizing gas. The first reactor outputs a stream comprising steam (H₂O) and carbon dioxide (CO₂) and potentially one or more inert components along with the unreacted input gases. The second reactor outputs a stream comprising a reduced product. As discussed below, the first reactor R1 may comprise multiple reactors, and the second reactor R2 may comprise multiple reactors. As discussed below, at some point the input streams to the first reactor R1 and the second reactor R2 are switched, such that the first reactor R1 receives oxidizing gas and the second reactor R2 receives reducing gas.

In some instances, exemplary recovery systems 104 comprise three sets of reactors. In some instances, each reactor is used as the reducer, the oxidizer, and the combustor at different times. In some instances, the first set of the reactors are used as the reducer, the second set of the reactor are used as the oxidizer, and the third set of reactors are used as the combustor.

Exemplary recovery systems 104 disclosed herein may be generally categorized into fixed bed systems and moving bed systems. Various aspects and configurations are discussed below. Although different configurations may be shown in different figures, various aspects of exemplary configurations may be combined.

### A. Exemplary Fixed Bed Configurations

In some instances, an exemplary configuration may comprise redox capable metal oxide-based particles in the fixed bed reactor. As discussed below, inlet and outlet gases can enter or exit the reactor through top, bottom, or side ports across the length of the reactor. Initially, the redox capable metal oxide-based particle fixed bed is reduced by the reducing gases from the input gas stream, followed by switching the gases to oxidizing gases (comprising, at least, H₂O and/or CO₂) for subsequent energy recovery by oxidizing/regenerating the redox capable metal oxide-based particles in the fixed bed reactor.

An exemplary configuration may comprise redox capable metal oxide-based particles in the core of a fixed bed reactor with the inert material particles placed in tube bundles surrounding the redox particles inside the reactor. Hot flue gas streams can be selectively provided through the tube bundles to heat up the inert particles for maintaining the desired operating temperature.

An exemplary configuration may comprise of redox capable metal oxide-based particles in a fixed bed reactor with internal and external heat transfer mechanism. Internal heat transfer mechanism may include jacketing the walls of fixed bed with a heat transfer media, or through an internal heat transfer coil, wherein the heat transfer media passes through the coil and performs heat transfer with the reactor contents. External heat transfer mechanism may include heat transfer across the inlet and/or the outlet streams by a heat exchanger. The heat exchanger can be used to perform heat integration across the system or throughout the plant.

Heat may be supplied or extracted by controlled injection of a supplementary reactive stream that can react with the gaseous and/or solid components present in the fixed bed, leading to an exothermic/endothermic reaction inside the reactor. For example, if the exemplary system generates endothermic reduction reactions, a supplementary stream of oxidizing gases comprising air, or oxygen stream or any other gas that reacts exothermically with the solid or gaseous components of the system, can be injected into the reactor during reduction operations to supply heat and maintain temperatures during reduction operations. Exemplary flow rates of supplementary streams may be between 0.1% to 10 times a flow rate of the primary input gas stream.

Alternatively, the supplementary stream may comprise an inert gas acting as a carrier gas and a heat transfer media. For example, if the exemplary system generates exothermic oxidation reactions, a supplementary stream of inert gas comprising nitrogen, or argon, excess steam, or any other carrier gas that extracts excess heat from the system, can be injected during oxidation to extract heat and maintain temperatures during oxidation operations. Exemplary flow rates of supplementary streams may be between 0.1% to 10 times of the primary input gas stream.

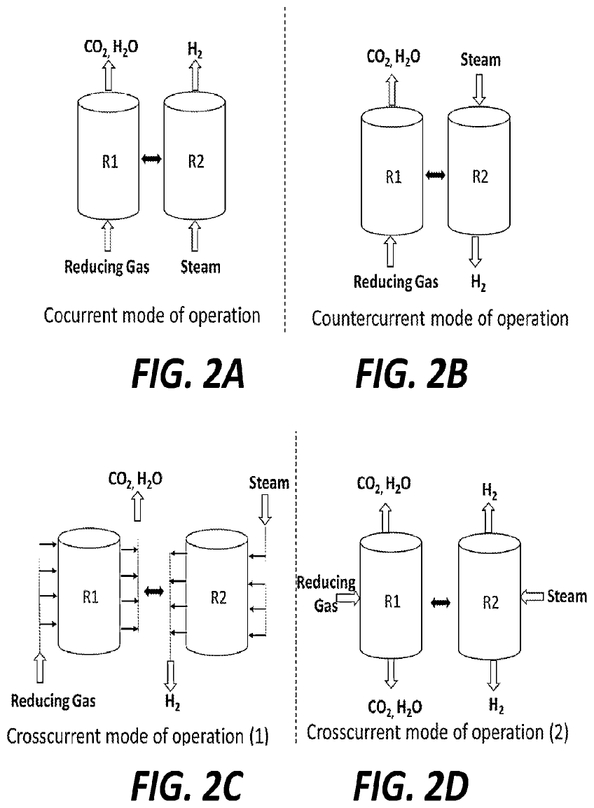

FIG. 2A and FIG. 2B show schematic depictions of co-current fixed bed and countercurrent fixed bed configurations, respectively for H₂ generation. As shown, each configuration generates hydrogen (H₂) through full/partial oxidation/regeneration of reduced metal oxide-based redox particles using steam. A co-current mode of operation, shown in FIG. 2A, involves both the reducing gases as well as steam flow in the same direction for a given reactor.

A countercurrent mode of operation, shown in FIG. 2B, involves reducing gases and steam flowing in opposite directions with respect to one another. Thus, the modes of operation differ with respect to the direction of the gas flows wherein the solids (metal oxide-based redox particles) remain in the fixed bed reactor.

FIG. 2C and FIG. 2D show schematic depictions of crosscurrent modes of operation. Crosscurrent modes of operation involve sideways injection across of reducing and/or oxidizing gas streams across the length of the reactor. Reactors R1 and R2 comprise redox particles in both configurations. As shown in FIG. 2C, reducing gas is provided to the reactors in a plurality of ports along a length of reactor R1 and/or reactor R2. As shown in FIG. 2C, product streams may also be collected from a plurality of ports along a length of reactor R1 and/or reactor R2. In various implementations, exemplary configurations may include between 2 and 50 input ports and/or output ports along a length of a reactor. In various implementations, exemplary configurations may include at least 2; at least 3 at least 4; at least 5; at least 6; at least 7; or at least 8 input ports and/or output ports along a length of a reactor.

Based on the pressure balances across the reactors, the flowrates on the inlet gases can be altered to get a sufficient gas residence times across the reactor. The distance between the ports can vary or stay constant based on the process parameters.

Because the systems utilize fixed bed-type reactor operation, multiple reactors may be used simultaneously, wherein at least one reactor undergoes reduction and at least one undergoes oxidation for hydrogen production. As shown in FIG. 2A, FIG. 2B, FIG. 2C, and FIG. 2D, reactor R1 is receiving reducing gas and reactor R2 is receiving steam. Gas switching from reducing gases to steam and vice versa typically occurs when the change in oxidation state of the metal oxide-based redox particles is complete. Thus, a subsequent operation of the reactors shown in FIG. 2A, FIG. 2B, FIG. 2C, and FIG. 2D would involve providing reducing gas to reactor R2 and steam to reactor R1.

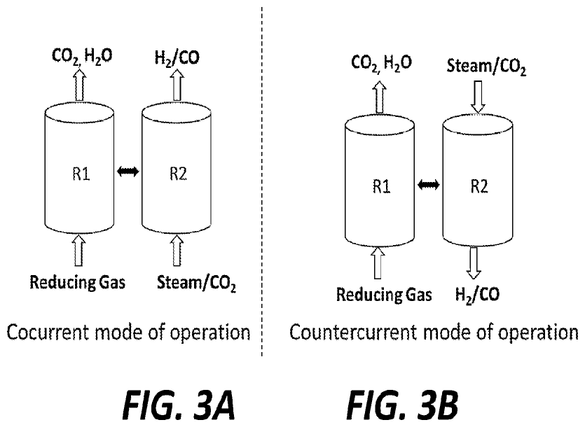

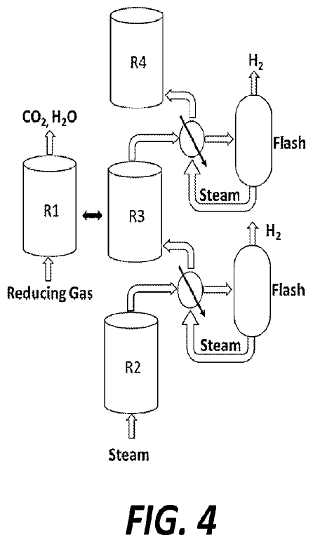

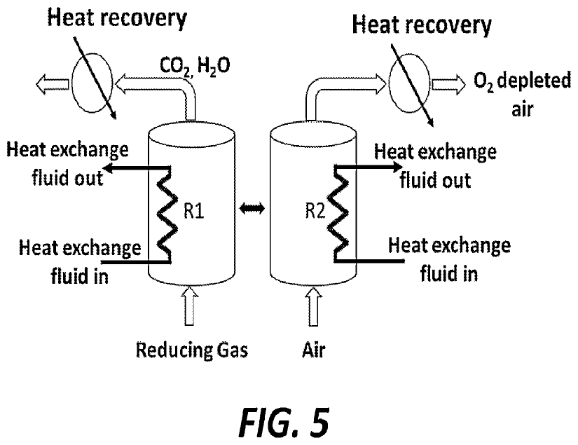

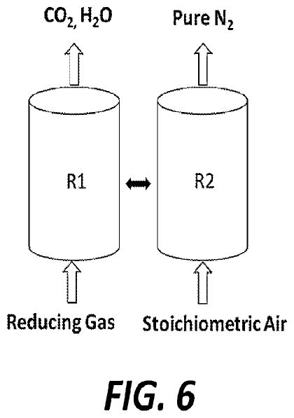

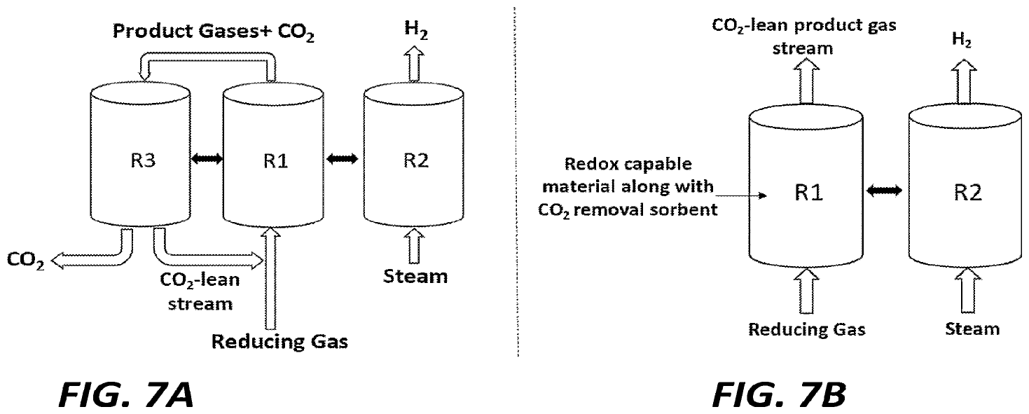

Similarly, the process configurations shown in FIG. 3A, FIG. 3B, FIG. 4, FIG. 5, FIG. 6, FIG. 7A and FIG. 7B, described in greater detail below, are for a single operational configuration. Accordingly, and as an example, input streams shown as comprising reducing gas may be switched to steam or steam and carbon dioxide (CO₂), and input streams shown as comprising steam or steam and carbon dioxide (CO₂) may be switched to reducing gas, where the switching may be based on or related to the oxidation state of the metal oxide-based redox particles.

FIG. 3A and FIG. 3B show schematic depictions of co-current fixed bed and countercurrent fixed bed configurations, respectively, for syngas generation. Reducing gases are first sent through one or more fixed beds comprising metal oxide-based redox particles, where the gases are converted into CO₂ and H₂O by abstracting the lattice oxygen from the redox particles. The redox particles may be subsequently oxidized using steam and CO₂ together for generating syngas, and thereby converting the incoming reducing gases into high-quality syngas (a mixture of H₂ and CO with the H₂/CO ratio varying from 0.1 to 5.0). The syngas quality may be controlled by changing the steam to CO₂ ratio based on downstream utilization of syngas.

Because the systems utilize fixed bed-type reactor operation, multiple reactors may be operated simultaneously such that at least one undergoes reduction (followed by oxidation) and at least one undergoes oxidation (followed by reduction) to complete the redox cycle. Steam and CO₂ fed into the reactor(s) during the oxidation operation can be supplied as fresh gas streams, or from the product gas exiting the fixed bed undergoing reduction, or a combination of both. Also, apart from co-feeding steam and CO₂ into the reactor during regeneration, pure CO₂ can also be used as an oxidizing media for generating high-purity CO stream.

FIG. 4 shows a schematic depiction of hydrogen generation wherein multiple fixed bed reactors comprising metal oxide-based redox particles are in fluid communication with at least one vapor-liquid separation unit. Each reactor in the exemplary system may be configured to receive reducing gas. Each reactor in the exemplary system may be configured to send an output to one or more vapor-liquid separation unit and receive an input from the one or more vapor-liquid separation units. In some instances, exemplary fixed bed reactors may be arranged to be operated in series.

In a first operation, reducing gases such are sent through the fixed beds to reduce the metal oxides, upon which steam oxidation is carried out. The unconverted steam/product H₂ exiting one fixed bed is subjected to a vapor-liquid separator (e.g., flash column, knock out drum, breakpot, suction drum) to recover hydrogen and the steam is again heated and sent to the subsequent fixed bed, thus enabling enhanced hydrogen recovery and steam utilization.

FIG. 5 shows a schematic depiction of a system configured for heat recovery, which may be applied to one or more other embodiments described herein. As shown, the metal oxide-based redox particles are first subjected to reduction using reducing gases, followed by oxidation using air. Because air oxidation of the reduced redox particles is highly exothermic, the heat evolved during their regeneration can be extracted and used elsewhere in the process.

FIG. 5 depicts two modes of heat recovery: internal and external modes of heat recovery. In the internal mode of heat recovery, the heat transfer fluid is used to extract heat from the reactor by circulation of heat transfer fluid. The fixed bed reactor may have a heat transfer fluid circulating in a jacket around the reactor walls or through internal coils that allow fluid flow. The heat transfer fluid may be water, which extracts the heat by formation of steam that can be used as utility in other processes. External mode of heat recovery is heat extraction from the outlet gases exiting the fixed bed reactor, through heat exchanger that can integrate the recovered heat anywhere across the plant. Apart from this, other modes of heat recovery and utilization include heat recovery from the hot exit gas streams after reduction, sending the product gas streams after reduction/oxidation operations for power generation, combusting the product gas streams after reduction/oxidation operations for heat recovery, or a combination of any of the modes described herein.

Exemplary metal oxide-based redox particles can be used as an energy reservoir for thermochemical heat storage, wherein reduction of the metal oxide can be brought about by thermochemical means through the reducing gases while using solar (or any other renewable/non-renewable heat source) energy as the heat source for providing elevated operating temperatures. Reduced metal oxide particles that possess high energy density can then be used for heat generation because their oxidation is highly exothermic in nature,

FIG. 6 shows a schematic depiction of a system configured for air separation. As shown, the exemplary system enables air separation for selective removal of oxygen from air, which may generate a high-purity N₂ stream. An exemplary process scheme may utilize a two-operation approach. In a first operation, reducing gases are used to reduce the metal oxide-based redox particles present in the fixed bed reactors. In a second operation, a stoichiometric amount of air (based on the amount of oxygen required to regenerate the reduced redox particles) is fed into a fixed bed. Molecular oxygen present in the air is used up by the reduced redox particles for its regeneration, thereby allowing generation of a pure N₂ stream exiting the reactor(s). Nitrogen produced in this manner can utilized for numerous industrial applications, such as chemical blanketing to prevent fires and explosions, electronics manufacturing to prevent overheating of processing systems, in processes that require a precise control over temperature, humidity, and oxygen levels, laser cutting, and chemicals production such as ammonia.

FIG. 7A shows a schematic depiction of a system configured to generate pure streams of CO₂ and hydrogen by utilizing another reactor(s) comprising materials capable or selectively removing CO₂. Reducing gases first enter reactor R1 to reduce the metal oxide-based redox particles. Unconverted gases comprising CO₂ exiting R1 enter reactor R3, which comprises material for selective CO₂ capture such as CaO to form CaCO₃. This material captures most of the CO₂ entering the reactor and the CO₂-lean product gas stream exiting R3 is recycled back to R1. Once the reduction operation in R1 is complete, it can be subjected to oxidation (equivalent to R2) to complete the redox loop. This process configuration thus utilizes two types of materials: one is the redox capable material that undergoes change in its oxidation state based on its interaction with gases of either reducing or oxidizing nature; and the other type includes a material with extremely high chemical affinity towards CO₂. The regeneration of this type of material is carried out by heating to obtain a pure CO₂ stream. As stated earlier, multiple fixed beds may operate sequentially to continuously generate hydrogen using this process configuration.

FIG. 7B shows a schematic depiction of a system wherein a CO₂ removal sorbent is fed into the fixed bed reactors along with the metal oxide-based redox particles for selective CO₂ capture. CO₂ from the reducing gas stream entering the fixed bed reactor may be captured using the sorbent material, thus enhancing the reducing potential of the gas mixture, and enabling a higher extent of reduction of the metal oxide-based redox particles.

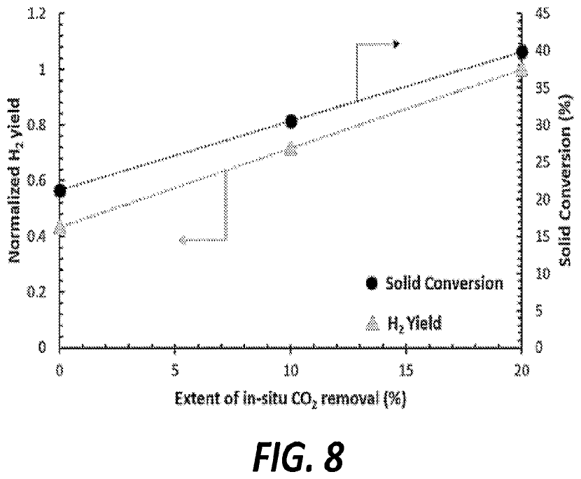

FIG. 8 is a computationally generated plot showing enhancement in hydrogen (H₂) yield upon in-situ removal of CO₂. A higher degree of reduction may result in a higher hydrogen (or any product) yield when the reduced redox particles is regenerated using steam to complete the redox loop as seen from FIG. 8. As compared to the base case of no in-situ removal of CO₂ from the fixed bed using a CO₂ sorbent, the H₂ yield increases by ˜65 and ˜130% upon sorbent-assisted selective removal of 10% and 20% CO₂, respectively. CO₂ captured by this means can be recovered in the form of a high purity stream by thermochemical means.

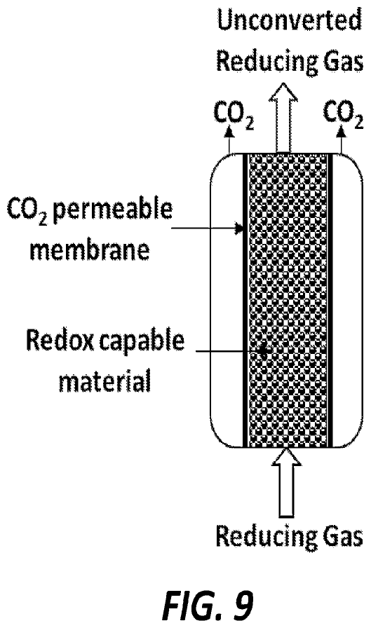

FIG. 9 shows a schematic configuration of a fixed bed reactor that utilizes a CO₂-selective membrane placed inside the reactor surrounding the metal oxide-based redox capable particles. The membrane selection is done such that it enables the permeation of only CO₂ gas molecules, while not allowing any other gases to pass through it, thus facilitating a higher extent of reduction of the metal oxide-based redox particles as the reducing potential of the reducing gas increases. Nonlimiting examples of such type of membranes include thin film composite membranes, block polymer membranes, coated membranes, etc.

During reduction operations in exemplary systems, reducing gases enter the fixed bed reactor to reduce the redox capable material through the lattice oxygen abstraction. As the reducing gas mixture typically contains CO₂ or it is generated in response to the oxidation of carbonaceous reducing gases, CO₂ is selectively removed by the membranes and the separated, high-purity CO₂ stream exits the reactor. Upon completion of this operation, steam is used to carry out the regeneration/reoxidation of the reduced redox capable material for generation of high purity hydrogen. As shown, where multiple fixed bed reactors operate in tandem, a continuous generation of hydrogen can be achieved. It should be noted that although hydrogen generation has been described here, the membrane-coupled system can also be used for generating other products such as CO, syngas, pure N₂, etc. based on the type of redox material and oxidizing media selected.

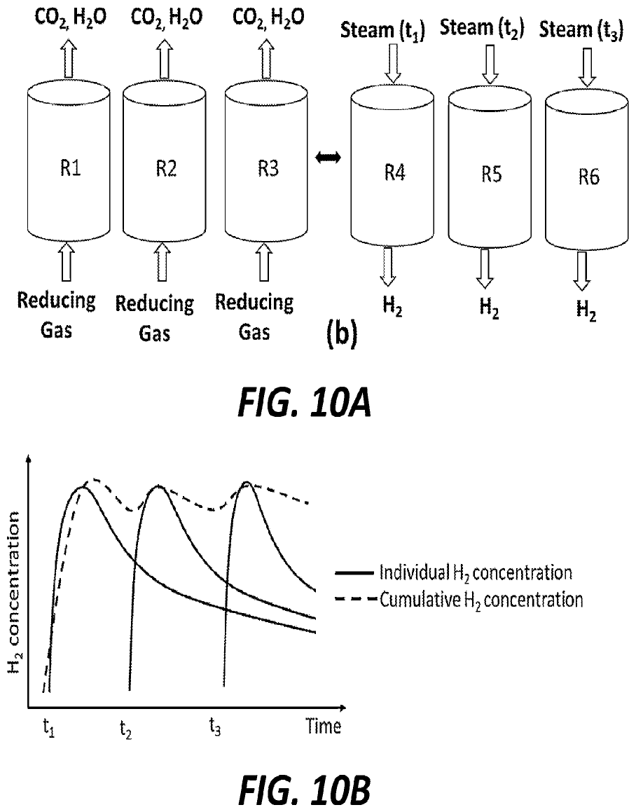

FIG. 10A shows a schematic depiction of two sets of reactors, where each set of reactors includes more than one reactor operating in parallel. In particular, FIG. 10A shows a countercurrent fixed bed system that uses multiple fixed beds operating in parallel with a time delay in the oxidizing gas (steam) injection. FIG. 10B shows a theoretical hydrogen yield for the system shown in FIG. 10A.

As shown, a continuous or semi-continuous supply of hydrogen may be obtained using a countercurrent mode of operation when the system utilizes multiple fixed bed reactors, wherein steam oxidation in one reactor can be followed by steam oxidation in another. The H₂ yield pattern can be modulated to arrive at a reasonably steady state output by applying multiple fixed bed reactors operating parallelly with a time delay.

During operation, as the H₂ yield from R4 starts to decrease after the peak, steam is injected into R5 at an appropriate time to modulate the amount of H₂ being generated by R4. Similarly, as the H₂ yield from R5 reaches a maximum and starts to decrease, H₂ is produced from R6 to modulate the outlet H₂ flow. Similar strategies may be applied to co-current configurations for regulating H₂ yield as well.

In exemplary implementations, multiple fixed beds can be operated in parallel, but in different mode of steam injection (co-current, counter-current or cross-current), to attain a steady flowrate of the product gas. For example, an initial surge in the H₂ concentration during the countercurrent operation may be used or stored for additional applications, while external H₂ can be supplied to supplement the lower H₂ yields during the initial co-current operation. Further ways of handling surge gas include recovery to be used in other process units, recycling back into the reactor, sending for energy recovery and storage, or any combination of the above.

### B. Exemplary Moving Bed Configurations

Exemplary implementations may comprise a moving bed of redox particles that circulates between various system components. The moving bed may circulate from a reducer reactor to an oxidizer reactor, and from the oxidizer reactor to a combustor reactor. A hopper or similar apparatus may be used to provide the moving bed to the reducer reactor. As the moving bed circulates, it may undergo a reduction operation with a fuel, an oxidation operation with CO₂ and/or H₂O to produce CO and/or H₂, respectively, and another oxidation operation with air to supply heat for the reduction operation.

Pneumatic particle conveying systems may be used to move the solid materials at elevated temperatures (i.e. >600° C.). In some instances, the movement of solids can result in particle attrition when employing pneumatic conveying systems. Mechanical conveying designs can be incorporated in the transport of the solids in exemplary systems to reduce particle attrition while being operable at the elevated operating temperatures of exemplary systems. One benefit of a process with mechanical conveying is that there is no pneumatical transport of redox particles. This prevents the fragmentation of particles due to motion prevalent in a circulating fluidized bed type of system.

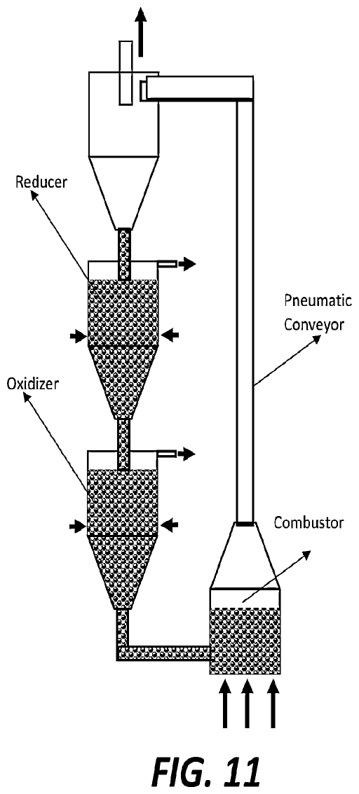

FIG. 11 shows a schematic configuration for a system comprising a moving bed of redox particles and pneumatic conveying apparatus. The example pneumatic conveying device transports redox particles between the combustor and the reducer. The reducer reactor converts fuel to products like syngas, chemicals or CO₂ using lattice oxygen from redox particles composed mainly with a metal-oxide. The reduced redox particles can be transported to the oxidizer where the reduced particles can be partially oxidized by steam to generate hydrogen. The partially oxidized redox particles are then transported to, and regenerated in, a combustor reactor using air as the oxidant.

The hydrodynamic contact pattern between the fuel and the redox particles in the reducer, the oxidizer and the combustor reactor can be a co-current and/or a counter current mode. For the convenience of the redox particle circulation in the exemplary system, pneumatic conveying of redox particles using exhaust gas of combustor, such as riser, is usually used. Typically, the redox particles are sized to be relatively small to allow for the pneumatic conveying. The pneumatic conveying of the solids particles may generate high attrition of the redox particles because of the high speed impingement of redox particles, which may cause defragmentation of the particles. As a result, the operational cost of the system can be very high.

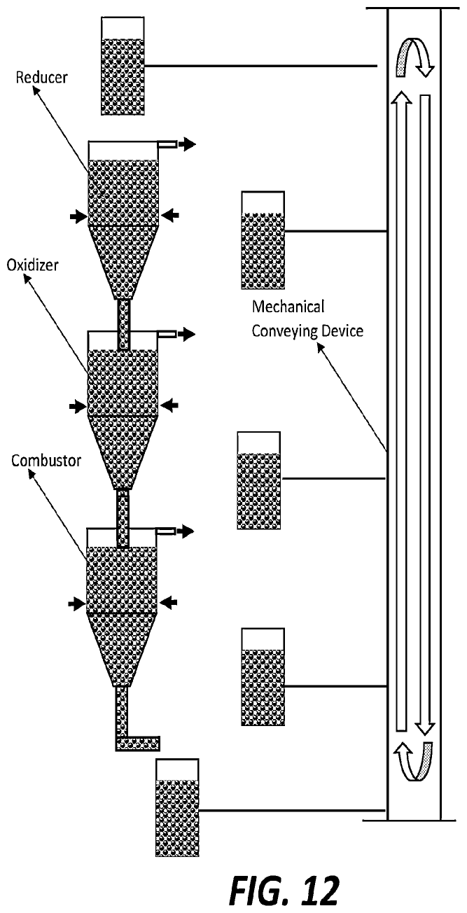

FIG. 12 shows an example of a reducer-oxidizer-combustor system that uses a mechanical conveying device to transport redox particles between the combustor and the reducer. In the embodiment shown in FIG. 12, the redox particles are separated from the process gas of the combustor after being fully regenerated. The redox particles are then discharged to a container which can be transported by a mechanical conveyor system to the top of the reducer. The mechanical conveyor system can use belts, buckets, chains, trays or any combination of these moving devices. The redox particles are then discharged from the container to the top of the reducer.

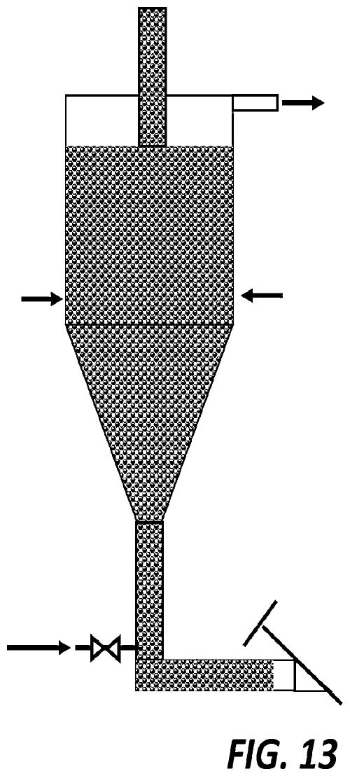

FIG. 13 schematically shows an exemplary combustor reactor. As shown, the combustor may be a moving bed reactor with solids inlet on the top and discharge from the bottom. The process gas can be sent in from the side ports located at the bottom section of the combustor and flow out of the combustor from the ports located on the top section of the combustor. A non-mechanical device may be installed at the solids outlet located at the bottom of the combustor to discharge regenerated redox particles with controlled flow rate. The non-mechanical device can be L-Valve, J-Valve, loop seal, seal port, or combinations thereof. The on and off of the solids discharge and its flow rate can be controlled by the aeration gas sent to the non-mechanic device. A gate valve can be installed at the end of the non-mechanic device to prevent heat loss from the system when there is no solids flow.

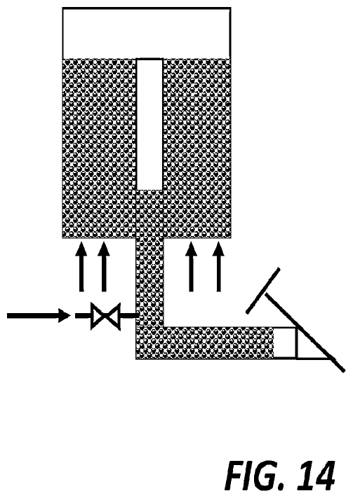

FIG. 14 schematically shows another exemplary combustor reactor. As shown, the combustor may be a moving bed reactor with solids discharge using an overflow device inside the combustor. The process gas can be sent in from the bottom of the combustor and flow out of the combustor from the ports located on the top of the combustor. The particles flowing to the top of the overflow device will flow to the discharge pipe. A non-mechanical device may be installed at the solids outlet to discharge regenerated redox particles with controlled flow rate. The non-mechanical device can be L-Valve, J-Valve, loop seal, seal port, or combinations thereof. The on and off of the solids discharge and its flow rate can be controlled by the aeration gas sent to the non-mechanic device. A gate valve can be installed at the end of the non-mechanic device to prevent heat loss from the system when there is no solids flow.

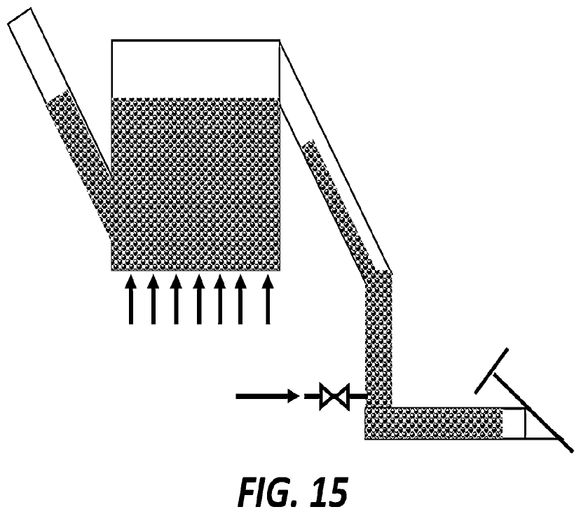

FIG. 15 schematically shows another exemplary combustor reactor. As shown, the combustor may be a moving bed reactor with solids discharge using an overflow device located at the top section of the combustor. The process gas can be sent in from the bottom of the combustor and flow out of the combustor from the ports located on the top of the combustor. The moving bed or fluidized bed operation mode can be realized by letting the velocity of the process gas inside the combustor be higher or lower than the minimum fluidization velocity of the redox particles under the operational conditions. The particles flowing to the port of the discharge pipe will flow out of the combustor. A non-mechanical device may be installed at the solids outlet to discharge regenerated redox particles with controlled flow rate. The non-mechanical device can be L-Valve, J-Valve, loop seal, seal port, or combinations thereof. The on and off of the solids discharge and its flow rate can be controlled by the aeration gas sent to the non-mechanic device. A gate valve can be installed at the end of the non-mechanic device to prevent heat loss from the system when there is no solids flow.

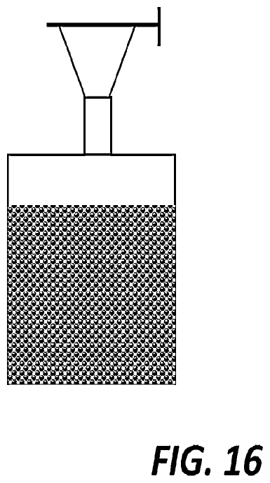

FIG. 16 is a schematic depiction of an exemplary particle container. As shown, the particle container can be designed to receive redox particles from the combustor. To prevent heat loss from the particles, the container can be insulated. The solids inlet of the container can be designed into a funnel shape to allow the smooth flow of the solids into the container. A gate valve can be installed at the top of the solids inlet of the container to prevent heat loss from the system. The gate valve opens before the container starts to take solids and closes after the solids inlet is completed.

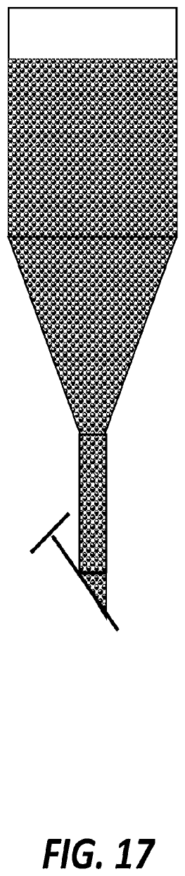

FIG. 17 is a schematic depiction of an exemplary particle container. As shown, the particle container can be designed to discharge redox particles from the bottom. A gate valve can be installed at the bottom of the solids to prevent particles from falling out. Typically, the valve is able to withstand the high temperature of the particles. The gate valve may open before the container starts to discharge solids particles to the reducer.

### IV. Exemplary Methods of Operation

Broadly, exemplary methods relate to the use of metal oxide-based materials that undergo the loss of lattice oxygen to get reduced and thereby act as energy reservoirs, where energy can be recovered in the form of heat and/or gaseous products through their regeneration using an appropriate oxidizing agent. Exemplary methods may utilize various system configurations that comprise one or more than one reactors. Reducing gases may be provided from various sources, including from other processes at a given operational location.

Exemplary recovery systems may be operated using various process schemes depending on the target application. Operating temperatures for exemplary embodiments may vary between 500° C. to 1200° C., where the selection of the actual operating temperature is a function of the redox particle reaction kinetics, process thermodynamics, and the system heat balance. As the desired operating temperature of the process is high, operating temperatures can be attained using conventional high-temperature furnaces operated using natural gas, coal, etc., electrical furnaces, solar concentrators, pre-heating of inlet gas streams, burning a fraction of inlet gas streams, or heat exchangers and heat integration across exemplary recovery systems and any other unit operation in its vicinity for waste heat recovery.

Operating pressures exemplary fixed bed recovery systems 104 can vary between 1-150 bar, with the actual selection being influenced by reaction kinetics, process thermodynamics, and overall process economics. In configurations with multiple fixed bed reactors, each reactor may be operated at uniform pressures or differential pressures such that the operating pressure during reduction operations and oxidation operations are independently controlled.

Exemplary methods for operating an energy recovery system may comprise one or more operations. An example method may begin by receiving a reducing gas stream that comprises at least one reducing gas species. The reducing gas stream may be provided to an inlet of the energy recovery system.

As discussed above, exemplary reducing gas streams may comprise waste gas streams exiting high-temperature furnaces, tail gases, natural gas/shale gas/methane (as makeup), biogas, and reducing gases from any chemical, petrochemical, refining, mining, metallurgical, ceramic, mineral, energy, bio-allied, agricultural or related environments. In some instances, reducing gases may comprise methane (CH₄), ethane (C₂H₆), hydrogen (H₂), carbon monoxide (CO), ethylene (C₂H₄), propane (C₃H₈), propylene (C₃H₆) and other C₂₊ hydrocarbons, or combinations thereof. Reducing gases from different sources can be used separately or mixed with one another in different proportions based on the thermodynamic and kinetic constraints imposed by the interaction between the reducing gas mixture and the metal oxide material.

The redox particles are contacted with the reducing gas stream, whereupon the at least one reducing gas species undergoes a chemical reaction with the redox particles to generate carbon dioxide (CO₂) and steam (H₂O). A first product stream comprising carbon dioxide (CO₂) and steam (H₂O) may be obtained from the energy recovery system. In some instances, the first product stream may additionally comprise unconverted gases.

In some instances, exemplary methods may comprise flushing operations between the reduction and oxidation operations to isolate the separate products and prevent contamination of reaction products. During flushing operations, an inert gas such as N₂, Ar, He, etc. may be purged into the reactor to remove the gaseous components from the previous operations.

After being contacted with the reducing gas stream, the redox particles may be contacted with an oxidizing gas stream. Exemplary oxidizing gas streams may comprise steam (H₂O), whereupon hydrogen gas (H₂) is generated. Then a second product stream comprising hydrogen gas (H₂) may be obtained from the energy recovery system.

In some instances, an oxidizing gas stream provided to the energy recovery system comprises carbon dioxide (CO₂) alone or further comprising steam (H₂O). In those implementations, the second product stream may comprise carbon monoxide (CO). In some instances, exemplary oxidizing gas streams may comprise steam (H₂O), carbon dioxide (CO₂), and one or more NOx gases, such as nitric oxide (NO) and nitrogen dioxide (NO₂).

In some instances, the reducing gas stream and the oxidizing gas stream are provided co-currently. In some instances, the reducing gas stream and the oxidizing gas stream are provided counter-currently.

In some instances, exemplary methods may comprise monitoring a concentration of carbon dioxide (CO₂) from an output of the reactor system when reducing gas is being provided to an inlet of the reactor. When the concentration of carbon dioxide (CO₂) falls below a predetermined threshold, the input stream may be changed from providing the reducing gas to providing an oxidizing gas. Similarly, exemplary methods may comprise monitoring a concentration of hydrogen (H₂) from an output of the reactor system when oxidizing gas is being provided to an inlet of the reactor. When the concentration of hydrogen (H₂) falls below a predetermined threshold, the input stream may be changed from providing the oxidizing gas to providing the reducing gas.

In some instances, exemplary methods may further comprise providing the second product stream to a separation unit, wherein the second product stream further comprises unconverted steam (H₂O). Then the separation unit may generate a first separation unit output stream comprising steam (H₂O) and a second separation unit output stream comprising hydrogen gas (H₂). In some instances, the first separation unit output stream may be provided to an input of the energy recovery system.

In some instances, exemplary methods may further comprise contacting the redox particles with air. In some instances, a stoichiometric amount of air is provided to the energy recovery system, and an output stream comprising substantially pure nitrogen (N₂) may be obtained. As used herein, substantially pure nitrogen may be a stream comprising at least 85% nitrogen (N₂); at least 87% nitrogen (N₂); at least 90% nitrogen (N₂); or at least 95% nitrogen (N₂).

In some instances, exemplary methods may further comprise contacting the first product stream with carbon dioxide (CO₂) capture materials, thereby generating a lean carbon dioxide (CO₂) stream. The lean carbon dioxide (CO₂) stream may be recycled and provided to an input of the energy recovery system. In some instances, the reducing gas stream contacts carbon dioxide (CO₂) capture materials in addition to the redox particles.

In some instances, contacting the reducing gas stream with redox particles occurs in a first reactor and contacting steam (H₂O) with the redox particles occurs in a second reactor. In those instances, exemplary methods may further comprise conveying redox particles from the first reactor to the second reactor using a mechanical conveying system.

In some instances, a plurality of reactors are operated in parallel and provided with reducing gas streams and/or oxidizing gas streams on a time delay. Exemplary methods may include providing an oxidizing gas to a first reactor at a first time, providing an oxidizing gas to a second reactor at a second time, where the second reactor is operating in parallel with the first reactor, and providing an oxidizing gas to a third reactor at a third time, where the third reactor is operating in parallel with the first reactor and the second reactor, and where the second time is after the first time and where the third time is after the second time.

In some instances, exemplary methods may include monitoring an output stream of the first reactor and, when a hydrogen (H₂) concentration drops below a predetermined threshold, providing the oxidizing gas to the second reactor. In some instances, exemplary methods may include monitoring an output stream of the second reactor and, when a hydrogen (H₂) concentration drops below a predetermined threshold, providing the oxidizing gas to the third reactor. In various implementations, the predetermined threshold may be 0.1% to 50.0% of the steady state concentration depending on the sensitivity of the downstream system.

In some instances, there may be a surge in the product yield or product concentration during the reduction/oxidation operation of the recovery system, depending on the method of operation and the inlet gases. This surge in the product gas may be handled in various ways to provide steady product flow to the downstream operation, or recovered to be used in other process units, or recycled back into the reactor, or sent for energy recovery and storage, or any combination of the above. In some instances, a maximum surge in product yield or product concentration may vary between 5% to 35 times of a constant desired product yield or product concentration, depending on the system and process parameters.

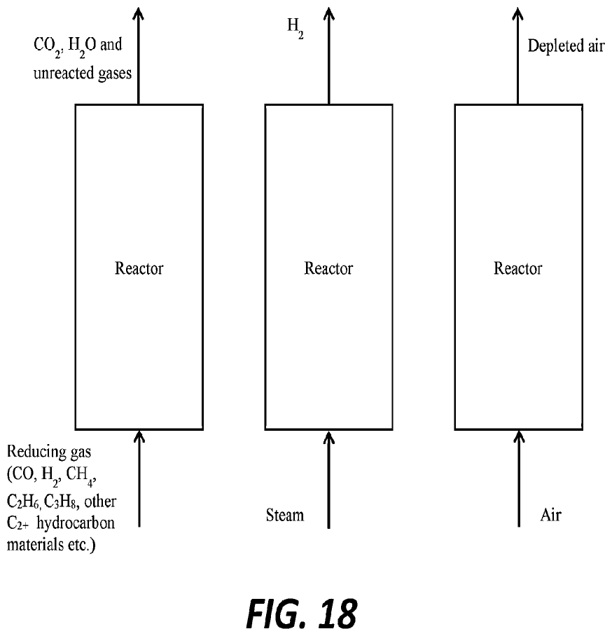

FIG. 18 schematically illustrates an example of operating an energy recovery system. FIG. 18 shows a single reactor's sequential operation, but exemplary operations may be performed in multiple reactors in a given system in parallel. In a first operation, reducing gas is provided to a reactor or group of reactors. The reducing gas is oxidized to form CO₂ and H₂O, while the redox particles in this sub-group of reactors is reduced by the reducing gas. In some instances, heat required for maintaining the reduction reaction in this sub-group of reactors may be provided by the heat released by the reaction between air and the redox particles in subsequent operations. In some instances, heat required by the reduction reaction may be provided from a heat source external to the reactors, such as the high temperature flue gas from a furnace or solar power.

In a second operation, steam is provided to the reactor or group of reactors. Hydrogen (H₂) is generated via the reaction with the reduced redox particles. In a third operation, air is provided to the reactor or group of reactors to regenerate the reduced redox particles. Reactors in other sub-groups may undergo similar reactions but at different times.

### V. Exemplary Implementations

Disclosed herein are systems and methods for energy recovery processes and other processes that enable solids transportation and circulation with mechanical conveying methods. The operation is achieved by installing mechanical conveying devices to receive redox particles from upstream reactor, transport to the top of the downstream reactor and discharge the redox particles into the downstream reactor. Systems using this strategy can enable the recovery system to operate without the pneumatical conveying devices which have high cost and generate high attrition rates on redox particles.

The said process can be used as a waste energy recovery system in other processes. Waste stream from an upstream process that comprises reducing gases, such as CO, H₂, CH₄, and other C₂₊ hydrocarbons, can be send to the recovery system as a fuel to the reducer reactor to reduce the redox material. The reduced redox material from the reducer can be used for H₂ generation in the oxidizer reactor. The generated H₂ can be used in the upstream process to reduce the consumption of other fuels and energy. The upstream process can be a chemical synthesis process, petrochemical process, metallurgy process, power generation process, or other processes that generates waste reducing gases. In certain configurations, the redox composite metal oxides can be used to process dilute flue gas or tail gas streams produce concentrated hydrogen and/or carbon monoxide for reuse in the process as a recovery system.

Fischer Tropsch gas to liquid processes are an example point source that consume large amounts of fuel for conversion into syngas and release tail gas, which primarily constitutes CO (10-20%), CO₂ (10-15%), CH₄ (20-30%), H₂ (15-30%), N₂ (10-20%), and higher hydrocarbons like C₂H₄ (3-5%). Waste gas streams containing reducing gases from other sources include tail gases commonly found in the petrochemical industry, whose average composition is typically CH₄ (1-5%), C2 gases (0-5%), C3 gases (0-5%), C4 gases (0-5%), CO (5-15%), CO₂ (1-10%), H₂ (10-40%), and N₂ (10-50%). Other emissions sources may include metallurgical operations that use coal/natural gas as a fuel for reducing the metal oxide ore and process it, such as production of iron from hematite, production of tin from cassiterite, reduction of ilmenite ore, etc. The gas streams include a mixture of reducing gases such as H₂, CO, CO₂, CH₄ and other C₂₊ gases with varying quantities depending on the application. Other sources of tail gas may include the Steam Methane Reforming (SMR) process which typically contains approximately CO₂ (45-50%), CO (10-15%), CH₄ (5-10%), H₂ (20-25%).

Exemplary methods and schemes disclosed herein may be utilized for flue gases exiting chemical, petrochemical, refining, mining, metallurgical, mineral, ceramic, energy, bio-allied, agricultural or related environments for different applications, such as power generation to high-value commodity production and chemical synthesis. Incorporating exemplary methods and systems into any upstream process may offer operational flexibility and turndown capacity while increasing the overall plant efficiency. Specifically, for an H₂ generation system, exemplary systems may be particularly suited for integration between the H₂ generation, purification, compression, and storage units to reduce the cost for H₂ based energy storage system. Because exemplary systems utilize redox capable metal oxides as an energy storage material, exemplary systems can store chemical energy as well as release it rapidly (e.g., in the form of H₂ upon steam oxidation of the reduced metal oxide material), and may enable rapid ramp-up and ramp-down of the downstream processes, thus enhancing the operational flexibility.

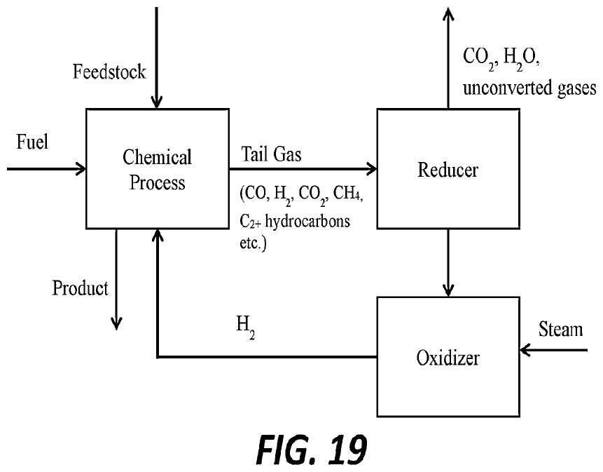

In one embodiment, as shown in FIG. 19, an exemplary system is used to recover energy from the tail gases in a Fischer Tropsch gas to liquid plant. The FT-reactor in the gas to liquid plant produces liquid fuels from syngas and generates a stream of tail gas, which comprises CO, H₂, CH₄, and reducing gases. The energy in the tail gas can be recovered by sending tail gas to the reducer, where the waste gas is converted to CO₂ and H₂O, with some unconverted gas while reducing the redox particles. The unconverted gases can be further utilized for recovering additional energy such as preheating the feedstocks. The reduced redox particles may be used to generate H₂ via its reaction with steam in the oxidizer. The H₂ generated from the process can be sent to the FT reactor for liquid fuels production, or used in other part of the plant, which may reduce the consumption of fuel in the plant. The solids can be in a continuous flow where the solids are moving from reducer to oxidizer in a circulatory fashion, or in non-flow system as a fixed bed, where the reducer and oxidizer are operated in swing fashion.

In another embodiment, an exemplary system can be used to process tail gas from various chemical process, as shown in FIG. 19. During reduction operations, exemplary metal oxide redox particles such as iron oxide can be reduced by the reducing tail gases in various processes and recover chemical energy in the gases via the following reaction:

CH₄/CO/H₂+FeOₓ→CO₂+H₂O+FeO_{y}(0≤y<x≤1.33)

When H₂ is generated by the processes, chemical energy stored in the redox particles can be released by passing process steam through the redox particles to generate H₂:

H₂O+FeO_{y}→H₂+FeOₓ(0≤y<x≤1.33)

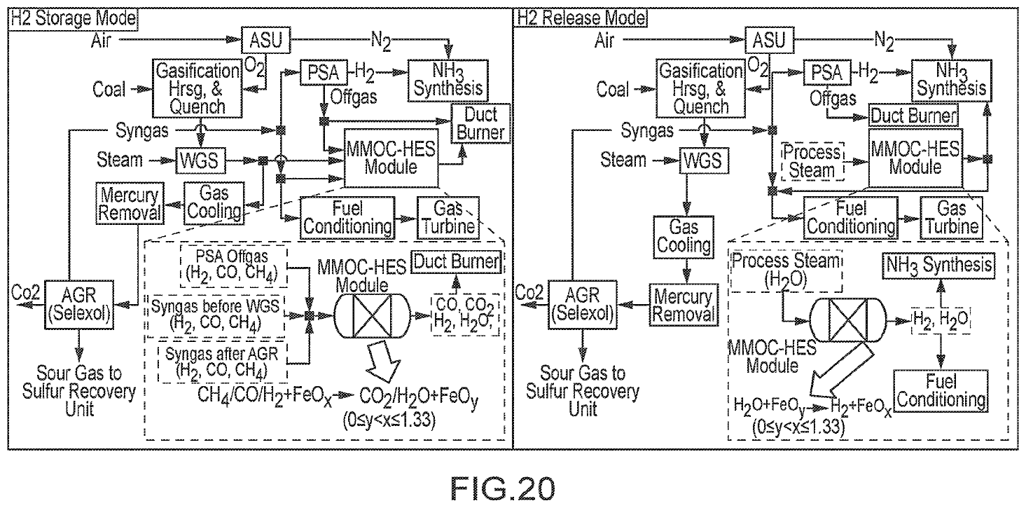

The high purity H₂ can be used for chemical synthesis or power production via fuel cells or gas turbines. Even though the chemical energy is recovered from low pressure tail gases, the high purity H₂ can be released at high pressure close to the process steam supply pressure. Compared to conventional H₂ based energy storage systems, the exemplary system shown in FIG. 20 integrates the H₂ generation, purification, compression, and storage units, which can reduce the cost for H₂ based energy storage system. Incorporating the system design may offer operational flexibility and turndown capacity. An example configuration may involve integrating a recovery system with a chemical plant designed to co-produce ammonia and electricity. Coal is gasified in an O₂-blown gasifier to produce syngas, which is converted to H₂ and CO₂ in the water-gas shift reactor. CO₂ is later removed by acid gas removal (AGR) process. The H₂-rich product gas is used for power generation in a combined cycle or ammonia production after purification in a pressure swing adsorption (PSA) unit.

During low electricity and H₂ demand, the exemplary system may consume a portion of the tail gas from the pressure swing adsorption (PSA) unit and additional syngas from the coal gasifier (as needed) to reduce the redox material to a lower oxidation state. The mode can be operated at low pressures to accommodate the PSA tail gas pressure. In the H₂ release mode, high pressure process steam is used to oxide the reduced redox material to produce high pressure, high purity H₂, which can be utilized in ammonia synthesis or in the gas turbine for power production. The exemplary system may be capable of releasing H₂ or storing chemical energy rapidly as steam or tail gas is introduced to the bed of redox material, which enables the rapid ramp-up and ramp-down of power and ammonia production in the coal-based poly-generation system, and thus enhancing the operational flexibility. Conventional H₂ storage and recovery technologies include physical-based (compressed or liquid H₂) and material-based (adsorbent, hybride, or chemical hydrogen) technologies.

The recovery system may store H₂ via the chemical potential of the reduced redox particles, which has much lower cost than adsorbents or chemicals used in material-based technologies. The recovery system has the ability to convert and store other reducing gases in the plant, avoiding the cost for additional reforming and purification processes for H₂ production. With iron oxide as the exemplary redox meratial, preliminary process analysis shows that the energy recovery system has higher H₂ storage density than other proceses, as shown in Table 1.

TABLE 1
Energy storage density of H₂ storage technologies

| | Energy | | Metal | | Chemical |
|---|---|---|---|---|---|
| Technology | Recovery | Compression | Hydride | Adsorbent | Hydrogen |
| H₂ storage | 1.4 | 0.8 | 0.4 | 0.7 | 1.3 |
| density | | | | | |
| (kWh/L) | | | | | |

### VI. Experimental Data

Experiments have been performed using Al—Zr supported Fe₂O₃—TiO₂ based redox particles. In these experiments, Fe₂O₃ serves as the active metal oxide component, performing redox reactions, whereas TiO₂ and the Al-based materials act as support materials to provide physical strength and to modulate the redox process.

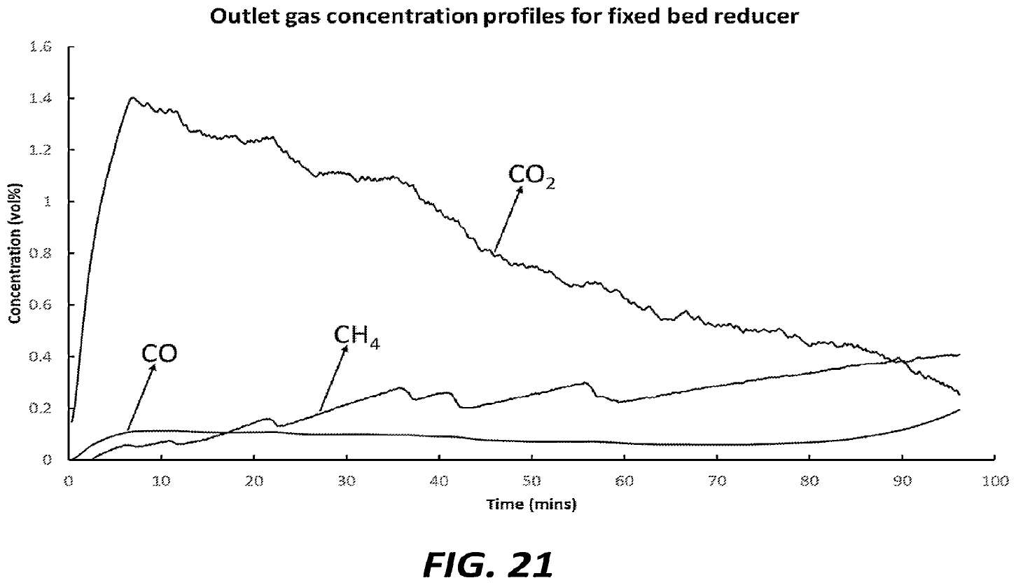

To illustrate the capability of an exemplary system to handle dilute reducing gas streams, a reduction experiment was performed isothermally at 1000° C. at 1 atm in a fixed bed reactor with 0.25 inch diameter and 6 inch bed height. FIG. 21 shows experimental results for a fixed bed receiving dilute methane gas in an exemplary system at 1000° C., 1 atm. The redox particles in the size range of 1000 μm-1500 μm mesh were used for performing redox cycles.

Reduction was carried out by providing a reducing gas mixture to the reactor at 200 ml/min. The reducing gas mixture comprised 10% by volume CH₄, with the remaining balanced with nitrogen. In the initial stage, the solids conversion was low, resulting in nearly full combustion of CH₄ to generate CO₂ with negligible CO (partial combustion product) at the outlet. The unconverted methane coming out of the reactor increased with time as the oxygen carriers in fixed bed oxygen were reduced by methane. The outlet gas concentration was measured online using SIEMENS IR based gas analyzers after cooling the outlet gases to room temperature and knocking out the moisture.

During the reduction operation, methane first came into contact with reduced particles at the inlet of the reactor with highest degree of reduction and generates a mixture of full and partial combustion products (CO₂, H₂O, CO and H₂), along with some unconverted methane. However, as this mixture travels along the length of the reactor, CO and H₂ are consumed because of a higher oxidation potential of the lesser reduced oxygen carrier particles. Methane reacts with the oxygen carrier particles as well, however, because of methane's slower reduction rates as compared to CO and H₂, unconverted CH₄ at the reducer outlet increases with time.

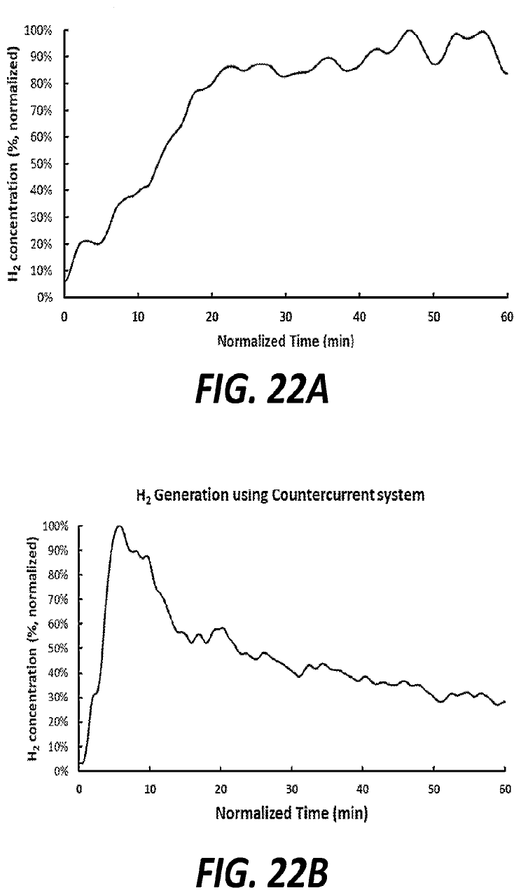

Upon completion of reduction operations, oxidation of the reduced oxygen carrier composites was performed using steam fed into the reactor at 200 ml/min. The steam produced is superheated steam at 140° C. and 1 atmospheric pressure. Two sets of experiments were performed: in co-current mode and in countercurrent mode. Experimental results of hydrogen generation for co-current and counter-current oxidizing gas configurations are shown in FIG. 22A and FIG. 22B, respectively. In co-current operation, both the reducing gas mixture as well as steam (oxidizing gas) were fed to the reactor in the same direction, whereas in the countercurrent operation, the reducing gas mixture and steam (oxidizing gas) were fed into the reactor in opposite directions. The outlet gas concentration was measured online using SIEMENS IR based gas analyzers after cooling to room temperature and knocking out any moisture present.

As shown in FIG. 22A, it takes about 20 minutes in this bench experiment to reach steady state, upon which the H₂ concentration remains almost constant for a period of time. However, if the steam oxidation is continued further, there would be a drop in H₂ concentration as the particles deplete their reduction potential. In other implementations, the time to reach steady state could differ depending on the size and dimensions of the reactor. In a co-current mode, steam first comes into contact with highest degree reduced particles and generates hydrogen. However, as this hydrogen and unconverted steam encounter the less reduced particles present along the length of the reactor, a portion of the hydrogen gets consumed due to a higher oxidation potential of the partially reduced oxygen carrier particles. The particles present at the reactor inlet become a bit less reduced whereas the particles present closer to the reactor outlet become a bit more reduced, thereby modulating the oxidation state of the entire bed and hence enabling a steady state H₂ profile. The hydrogen produced in this manner can be directly sent to downstream process for use.

FIG. 22B shows the H₂ concentration profile of a system operated in a countercurrent mode. As the steam entering the reactor first encounters the least reduced oxygen carrier particles, the steam/redox particle interaction generates small quantities of hydrogen because the solid conversion of the particles is low. The unconverted steam then comes into contact with the highly reduced oxygen carrier particles and thus generates a greater amount of hydrogen rapidly (˜5 min for this scale of experiment, which could differ for different reactor sizes) upon which the H₂ concentration drops as the bed material gets used up and its H₂ generation potential continuously keeps dropping. As a result, a steady state operation is not obtained in this mode of operation, as seen from FIG. 22B.

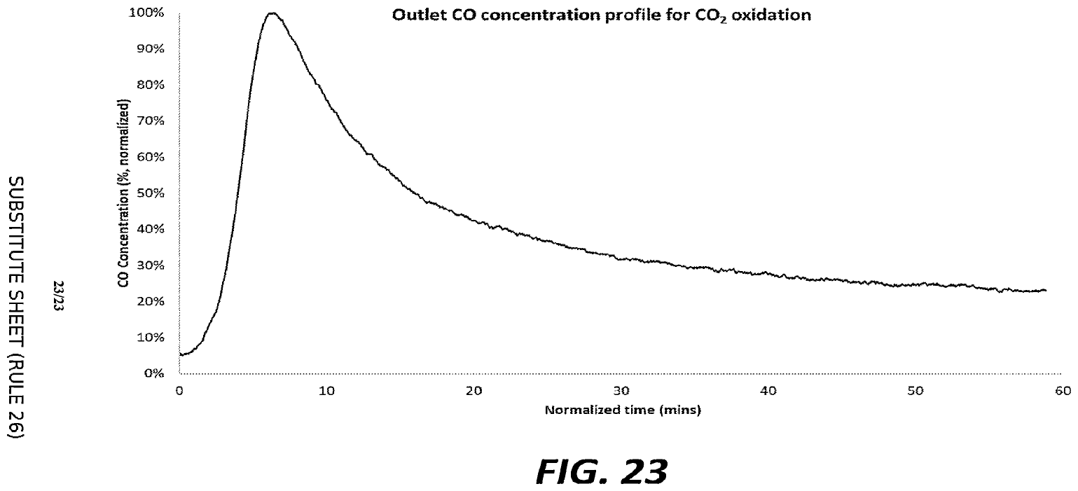

Another example of the CO generation from CO₂ oxidation, FIG. 23 illustrates the product CO concentration profile of an system operated in a countercurrent mode. Similar to steam oxidation, as the CO₂ entering the reactor first encounters the least reduced oxygen carrier particles, a small quantity of CO gas is generated. Unconverted CO₂ further reacts with the highly reduced oxygen carrier particles and thus generates CO rapidly (˜7.5 min). This results in a drop in the CO concentration as the bed material gets used up and its CO generation potential continuously keeps dropping. Like countercurrent steam oxidation, a steady state operation is not obtained as seen from FIG. 23. Exemplary systems can be configured for generating desired qualities of syngas by using a mixture of steam and CO₂ for fixed bed oxidation. For example, if syngas of H₂:CO ratio of 2:1 is desired, oxidation experiments can be conducted by varying the H₂O:CO₂ ratio in the inlet oxidizing gas and analyzing the H₂:CO ratio of the outlet product.

The flow pattern presented in these sample experiments involves flushing the reaction between the oxidation and the reduction operations. However, if no flushing operation is involved between the reduction and oxidation operations, the flow pattern for both co-current and countercurrent operations differ in the initial few minutes of the operating time frame, with precise profiles varying with the concentration of H₂ contained in the inlet reducing gas and the desorption pattern of the reducing gas species adsorbed on the oxygen carriers.

These experiments are a proof of concept for the operating strategy while the process parameters of an exemplary system can be adjusted to change the solid conversions during reduction as well as oxidation. Thus, the solid conversion can vary from 0% to 100% or across any values in between during both reduction and oxidation operations of the redox cycle, such that a fixed difference over the extents of the solid conversions is maintained between the reduction and oxidation operations across extended redox cycles. Also, the length of the fixed bed operation, i.e., time for which reduction or regeneration of the oxygen carrier may be carried out, can be determined based on the reaction kinetics, wherein fast and slow reaction kinetics will yield short and longer operation time, respectively. Without being bound by a particular theory, it is believed that the concentration profile would be generic regardless of the oxygen carrier material used in the redox process.

The reduction and oxidation reactions can be exothermic or endothermic depending on the types of reactions and oxygen carriers used. If the reaction is carried out in exothermic conditions, the temperature of the system would increase, whereas the temperature of the system would decrease if the reaction were carried out in endothermic conditions. Temperature control can be achieved through heat exchanging mechanisms applied either internally or externally using flue gases generated from conventional combustion at high-temperature furnaces operated using natural gas, coal, etc., or using solar concentrators, pre-heating of inlet gas streams, burning a fraction of inlet gas stream, or using heat exchangers with heat integration across any the system and any other unit operation in its vicinity for waste heat recovery. The heat requirement may be properly balanced for the perpetual operation of the system.

The current chemical looping metal oxide oxygen carrier systems can be extended in applications or operation to other chemical looping systems using other metal derivatives such as metal sulfide, metal hydride, metal carbide or metal nitride, for reactions.

### Embodiments

Embodiments of the present disclosure are disclosed in the following clauses:

Embodiment 1. A method for operating an energy recovery system, the method comprising:
providing a reducing gas stream to an inlet of the energy recovery system, the reducing gas stream comprising at least one reducing gas species comprising at least one of carbon monoxide (CO), methane (CH₄), hydrocarbons (C₂₊), hydrogen gas (H₂), and carbon dioxide (CO₂);
contacting redox particles with the reducing gas stream, whereupon the at least one reducing gas species undergoes a chemical reaction with the redox particles to generate carbon dioxide (CO₂) and/or steam (H₂O);
obtaining a first product stream from the energy recovery system, the first product stream comprising carbon dioxide (CO₂) and steam (H₂O);
providing an oxidizing gas stream comprising steam (H₂O) to the energy recovery system such that hydrogen gas (H₂) is generated; and
obtaining a second product stream from the energy recovery system, the second product stream comprising hydrogen gas (H₂).

Embodiment 2. The method according to Embodiment 1, wherein the oxidizing gas stream further comprises carbon dioxide (CO₂); and
wherein the second product stream further comprises carbon monoxide (CO).

Embodiment 3. The method according to Embodiment 1 or Embodiment 2, wherein the reducing gas stream and the oxidizing gas stream are provided co-currently.

Embodiment 4. The method according to any one of Embodiments 1-3, wherein the reducing gas stream and the oxidizing gas stream are provided counter-currently.

Embodiment 5. The method according to any one of Embodiments 1-4, further comprising:
providing the second product stream to a separation unit, wherein the second product stream further comprises unconverted steam (H₂O);
obtaining a first separation unit output stream comprising steam (H₂O); and
obtaining a second separation unit output stream comprising hydrogen gas (H₂).

Embodiment 6. The method according to Embodiment 5, further comprising providing the first separation unit output stream to an input of the energy recovery system.

Embodiment 7. The method according to any one of Embodiments 1-6, further comprising contacting the redox particles with air.

Embodiment 8. The method according to Embodiment 7, wherein a stoichiometric amount of air is provided to the energy recovery system, and further comprising:
obtaining a nitrogen (N₂) stream comprising at least 85% nitrogen (N₂).

Embodiment 9. The method according to any one of Embodiments 1-8, further comprising:
contacting the first product stream with carbon dioxide (CO₂) capture materials, thereby generating a lean carbon dioxide (CO₂) stream; and
providing the lean carbon dioxide (CO₂) stream to an input of the energy recovery system.

Embodiment 10. The method according to any one of Embodiments 1-9, wherein the reducing gas stream contacts carbon dioxide (CO₂) capture materials in addition to the redox particles.

Embodiment 11. The method according to any one of Embodiments 1-10, wherein contacting the reducing gas stream with redox particles occurs in a first reactor; and wherein contacting steam (H₂O) with the redox particles occurs in a second reactor.

Embodiment 12. The method according to any one of Embodiments 1-11, further comprising conveying redox particles from the first reactor to the second reactor using a mechanical conveying system.

Embodiment 13. The method according to any one of Embodiments 1-12, wherein contacting the reducing gas stream with redox particles occurs in a first reactor; and
wherein contacting steam (H₂O) with the redox particles occurs in the first reactor.

Embodiment 14. The method according to any one of Embodiments 1-13, further comprising contacting the reducing gas stream with inert material particles.

Embodiment 15. The method according to any one of Embodiments 1-14, wherein the reducing gas stream is provided cross-currently relative to a length of a reactor in the energy recovery system.

Embodiment 16. The method according to any one of Embodiments 1-15, wherein the reducing gas stream is provided at a plurality of inputs spaced along the length of the reactor.

Embodiment 17. The method according to any one of Embodiments 1-16, wherein providing the oxidizing gas stream is conducted at a first time and to a first reactor, and further comprising:
providing the oxidizing gas stream to a second reactor at a second time, the second time being after the first time and the second reactor operating in parallel with the first reactor.

Embodiment 18. The method according to any one of Embodiments 1-17, further comprising providing the oxidizing gas stream to a third reactor at third time, the third time being after the second time and the third reactor operating in parallel with the second reactor.

Embodiment 19. The method according to any one of Embodiments 1-18, further comprising flushing the energy recovery system with an inert gas after obtaining the first product stream and before providing an oxidizing gas stream.

Embodiment 20. The method according to any one of Embodiments 1-19, further comprising providing heat transfer liquid to an internal heat transfer unit positioned within the energy recovery system.

Embodiment 21. The method according to any one of Embodiments 1-20, further comprising providing heat transfer media to an external heat transfer unit positioned outside, but in contact with, the energy recovery system.

Embodiment 22. The method according to any one of Embodiments 1-21, further comprising recycling the first product stream back to the energy recovery system.

Embodiment 23. The method according to any one of Embodiments 1-22, further comprising injecting a supplemental reactant stream.

Embodiment 24. The method according to Embodiment 23, wherein the supplemental reactant stream comprises air or oxygen.

Embodiment 25. The method according to Embodiment 23, wherein the supplemental reactant stream comprises nitrogen, argon, or steam.

Embodiment 26. The method according to any one of Embodiments 1-25, wherein the oxidizing gas stream is provided to a first reactor, and further comprising:
providing the oxidizing gas stream to at least one additional reactor operating in parallel with the first reactor, wherein providing the oxidizing gas stream to the at least one additional reactor is performed in co-current, counter-current, or cross-current orientation.

Embodiment 27. The method according to any one of Embodiments 1-26, further comprising receiving a surge from the second product stream; and
providing the surge to at least one of: storage, downstream process equipment, or back into the reducing gas stream.

Embodiment 28. The method according to any one of Embodiments 1-27, further comprising providing at least one of the first product stream or the second product stream to an energy recovery unit, the energy recovery unit performing at least one of: combusting, generating steam, preheating the reducing gas stream, or generating electricity.

Embodiment 29. The method according to any one of Embodiments 1-28, the first product stream further comprising unconverted gases.

Embodiment 30. The method according to any one of Embodiments 1-29, further comprising contacting the redox particles with oxidizing gas comprising NOx gases.

Embodiment 31. A reactor system comprising:
a first reactor comprising redox particles;
a second reactor in fluid communication with the reducer reactor and configured to receive the redox particles from the reducer reactor;
a combustor reactor in fluid communication with the oxidizer reactor and configured to receive the redox particles from the oxidizer reactor,
   wherein the combustor reactor comprises a particle flow control module; and
a conveying system in communication with the particle flow control module and the reducer reactor, the conveying system configured to mechanically convey the redox particles from the particle flow control module to the reducer reactor.

Embodiment 32. The reactor system according to Embodiment 31, wherein the conveying system comprises a conveyor.

Embodiment 33. The reactor system according to Embodiment 31 or Embodiment 32, wherein the particle flow control module comprises an L-valve, a J-valve, a loop seal, a seal port, or a combination thereof.

Embodiment 34. The reactor system according to any one of Embodiments 31-33, wherein the particle flow control module further comprises an aeration gas input and a mechanical valve adjacent an output of the particle flow control module.

1. A method for operating an energy recovery system, the method comprising:
providing a reducing gas stream to an inlet of the energy recovery system, the reducing gas stream comprising at least one reducing gas species comprising at least one of carbon monoxide (CO), methane (CH₄), hydrocarbons (C₂₊), hydrogen gas (H₂), and carbon dioxide (CO₂);
contacting redox particles with the reducing gas stream, whereupon the at least one reducing gas species undergoes a chemical reaction with the redox particles to generate carbon dioxide (CO₂) and/or steam (H₂O);
obtaining a first product stream from the energy recovery system, the first product stream comprising carbon dioxide (CO₂) and steam (H₂O);
providing an oxidizing gas stream comprising steam (H₂O) to the energy recovery system such that hydrogen gas (H₂) is generated; and
obtaining a second product stream from the energy recovery system, the second product stream comprising hydrogen gas (H₂).

2. The method according to claim 1, wherein the oxidizing gas stream further comprises carbon dioxide (CO₂); and
wherein the second product stream further comprises carbon monoxide (CO).

3. The method according to claim 2, wherein the reducing gas stream and the oxidizing gas stream are provided co-currently; and further comprising contacting the reducing gas stream with inert material particles.

4. The method according to claim 2, wherein the reducing gas stream and the oxidizing gas stream are provided counter-currently; and further comprising contacting the reducing gas stream with inert material particles.

5. The method according to claim 1, further comprising:
providing the second product stream to a separation unit, wherein the second product stream further comprises unconverted steam (H₂O);
obtaining a first separation unit output stream comprising steam (H₂O);
obtaining a second separation unit output stream comprising hydrogen gas (H₂); and
providing the first separation unit output stream to an input of the energy recovery system.

6. (canceled)

7. The method according to claim 1, further comprising contacting the redox particles with air;
wherein a stoichiometric amount of air is provided to the energy recovery system, and further comprising:
obtaining a nitrogen (N₂) stream comprising at least 85% nitrogen (N₂).

8. (canceled)

9. The method according to claim 1, further comprising:
contacting the first product stream with carbon dioxide (CO₂) capture materials, thereby generating a lean carbon dioxide (CO₂) stream; and
providing the lean carbon dioxide (CO₂) stream to an input of the energy recovery system,
wherein the reducing gas stream contacts carbon dioxide (CO₂) capture materials in addition to the redox particles.

10. (canceled)

11. The method according to claim 1, wherein contacting the reducing gas stream with redox particles occurs in a first reactor; and
wherein contacting steam (H₂O) with the redox particles occurs in a second reactor
further comprising conveying redox particles from the first reactor to the second reactor using a mechanical conveying system.

12. (canceled)

13. The method according to claim 1, wherein contacting the reducing gas stream with redox particles occurs in a first reactor; and
wherein contacting steam (H₂O) with the redox particles occurs in the first reactor.

14. (canceled)

15. The method according to claim 1, wherein the reducing gas stream is provided cross-currently relative to a length of a reactor in the energy recovery system; and
wherein the reducing gas stream is provided at a plurality of inputs spaced along the length of the reactor.

16. (canceled)

17. The method according to claim 1, wherein providing the oxidizing gas stream is conducted at a first time and to a first reactor, and further comprising:
providing the oxidizing gas stream to a second reactor at a second time, the second time being after the first time and the second reactor operating in parallel with the first reactor; and
providing the oxidizing gas stream to a third reactor at third time, the third time being after the second time and the third reactor operating in parallel with the second reactor.

18. (canceled)

19. The method according to claim 1, further comprising flushing the energy recovery system with an inert gas after obtaining the first product stream and before providing an oxidizing gas stream.

20. The method according to claim 1, further comprising:
providing heat transfer liquid to an internal heat transfer unit positioned within the energy recovery system; and/or
providing heat transfer media to an external heat transfer unit positioned outside, but in contact with, the energy recovery system.

21. (canceled)

22. The method according to claim 1, further comprising recycling the first product stream back to the energy recovery system.

23. The method according to claim 1, further comprising injecting a supplemental reactant stream comprising air, oxygen, nitrogen, argon, or steam.

24-25. (canceled)

26. The method according to claim 1, wherein the oxidizing gas stream is provided to a first reactor, and further comprising:
providing the oxidizing gas stream to at least one additional reactor operating in parallel with the first reactor, wherein providing the oxidizing gas stream to the at least one additional reactor is performed in co-current, counter-current, or cross-current orientation.

27. The method according to claim 1, further comprising receiving a surge from the second product stream; and
providing the surge to at least one of: storage, downstream process equipment, or back into the reducing gas stream.

28. The method according to claim 1, further comprising providing at least one of the first product stream or the second product stream to an energy recovery unit, the energy recovery unit performing at least one of: combusting, generating steam, preheating the reducing gas stream, or generating electricity.

29. The method according to claim 1, the first product stream further comprising unconverted gases.

30. The method according to claim 1, further comprising contacting the redox particles with oxidizing gas comprising NOx gases.

31. A reactor system comprising:
a first reactor comprising redox particles;
a second reactor in fluid communication with the reducer reactor and configured to receive the redox particles from the reducer reactor;
a combustor reactor in fluid communication with the oxidizer reactor and configured to receive the redox particles from the oxidizer reactor,
wherein the combustor reactor comprises a particle flow control module; and
a conveying system in communication with the particle flow control module and the reducer reactor, the conveying system configured to mechanically convey the redox particles from the particle flow control module to the reducer reactor.

32. The reactor system according to claim 31, wherein the conveying system comprises a conveyor;
wherein the particle flow control module comprises an L-valve, a J-valve, a loop seal, a seal port, or a combination thereof; and
wherein the particle flow control module further comprises an aeration gas input and a mechanical valve adjacent an output of the particle flow control module.

33-34. (canceled)
